(19) United States
(12) Patent Application Publication
(10) Pub. No.: US 2014/0115172 A1
(43) Pub. Date: Apr. 24, 2014

(54) COMMUNICATION TERMINAL DEVICE

(71) Applicant: MURATA MACHINERY, LTD., Kyoto-shi (JP)

(72) Inventor: Toshinari AGATA, Kyoto-shi (JP)

(73) Assignee: MURATA MACHINERY, LTD., Kyoto-shi (JP)

(21) Appl. No.: 14/034,784

(22) Filed: Sep. 24, 2013

(30) Foreign Application Priority Data
Oct. 24, 2012 (JP) 2012-234833

(51) Int. Cl. H04L 29/06

(52) U.S. Cl. CPC H04L 65/1069
USPC 709/227

(57) ABSTRACT

In a communication terminal device, a receiving unit establishes a non-persistent connection with an Operating System OS of a computer and receives a request from the OS via the non-persistent connection. A response generating unit generates data for response to the request. A transmitting unit transmits the data for response to the OS via the non-persistent connection after a predetermined waiting time elapses from reception of the request. The non-persistent connection is established every time the OS transmits the request and is closed by the OS's reception of the response.

### CROSS-REFERENCE TO RELATED APPLICATIONS

This application claims priority under 35 U.S.C. 119 to Japanese Patent Application No. 2012-234833 filed on Oct. 24, 2012, which application is hereby incorporated by reference in its entirety.

### BACKGROUND OF THE INVENTION

1. Field of the Invention

The present invention relates to communication between a communication terminal device and an operating terminal device.

2. Description of the Related Art

A communication terminal device such as a network printer, for example, is configured to be capable of exchanging information with an operating terminal device such as a PC (Personal Computer) via a network. Such a configuration is described in, for example, Japanese Unexamined Patent Publication No. 2003-18181.

Japanese Unexamined Patent Publication No. 2003-18181 discloses a configuration that allows communication via internet between a communication terminal device (operated device) adapted to control lighting and a blind, and an operating terminal device (operating terminal). Japanese Unexamined Patent Publication No. 2003-18181 also relates to a configuration that establishes a persistent connection between the communication terminal device and the operating terminal device. Japanese Unexamined Patent Publication No. 2003-18181 discloses a configuration that includes a response control means adapted to return a reception response after waiting for a predetermined time in a case of receiving a predetermined request signal. According to Japanese Unexamined Patent Publication No. 2003-18181, this allows for maintaining the persistent connection without causing unnecessary burden on the network.

Japanese Unexamined Patent Publication No. 2003-18181 assumes that the persistent connection is established between the communication terminal device and the operating terminal device. On the other hand, in a case of establishing a non-persistent connection (that is, in a case where a connection is cut after transmission/reception is performed one time) it is not required to wait for a predetermined time before returning a receipt response as required in Japanese Unexamined Patent Application Publication No. 2003-18181. On the contrary, in a case of a non-persistent connection, it is considered that a response to a request is preferably returned as soon as possible in view of improving responsiveness.

Recently, processing capabilities of communication terminal devices have been improved with shorter time required to process generation of data for response to a request. Consequentially, a response can be immediately returned to a request from an operating terminal device.

However, as a result of discoveries made by the inventor of the present application, it has become clear that in a case where a response is returned from a recent communication terminal device with improved processing speed to an operating terminal device, an OS (Operating System) of the operating terminal device exhibits an unexpected behavior in some cases.

### SUMMARY OF THE INVENTION

In consideration of the above-described circumstances, preferred embodiments of the present invention prevent an operating terminal device from exhibiting unexpected behavior that is caused by a response returned from a communication terminal device.

According to a preferred embodiment of the present invention, a communication terminal device includes a receiving unit, a response generating unit, and a transmitting unit. The receiving unit is configured to receive a request via a non-persistent connection established via a network with an OS of an operating terminal device. The response generating unit is configured to generate data for response to the request. The transmitting unit is configured to transmit the data for response to the OS via the non-persistent connection after a predetermined waiting time elapses from reception of the request. The non-persistent connection is established every time the OS transmits the request and is closed by the OS's reception of the response.

In other words, recent communication terminal devices are capable of immediately generating data for response as a result of improved processing speed. However, when a response was immediately returned to a request from an operating terminal device, the OS of the operating terminal device exhibited an unexpected behavior in some cases. Therefore, with the above-described configuration, by preventing a response to a request from being immediately returned, the OS of the operating terminal device has ceased to exhibit the unexpected behavior.

A communication terminal device according to a preferred embodiment of the present invention preferably includes a measuring unit arranged to measure generation time from reception of the request until the response generating unit completes generation of the data for response. In a case where the generation time is shorter than the waiting time, the transmitting unit is configured to wait to transmit the data for response for a period of time from reception of the request until the waiting time elapses. In a case where the generation time is longer than the waiting time, the transmitting unit is configured to transmit the data for response without waiting.

As described above, in a case where data for response is prepared in a time shorter than the waiting time, the transmitting unit is configured to wait to transmit the data. This reliably prevents that an OS of an operating terminal device exhibits an unexpected behavior. On the other hand, in a case where preparation of data for response requires a time longer than the waiting time, a decrease in responsiveness is prevented by immediately transmitting the data.

The communication terminal device preferably includes a waiting time setting unit arranged to set a plurality of waiting times.

By preparing to set the plurality of waiting times, an appropriate waiting time can be selected according to a condition.

The communication terminal device may be configured as follows. That is, the waiting time setting unit is preferably configured to set the plurality of waiting times corresponding to protocols. The transmitting unit is configured to select and use any one of the plurality of waiting times set in the waiting time setting unit according to a protocol of a non-persistent connection.

Since this allows the waiting time to be varied by protocol, a response can be returned at an appropriate timing according to the protocol.

The communication terminal device may be configured as follows. That is, the waiting time setting unit is preferably configured to set the plurality of waiting times to be compatible with port numbers. The transmitting unit is configured to select and use any one of the plurality of waiting times set in the waiting time setting unit according to a port number of the OS.

Since this allows the waiting time to be varied by port number, a response can be returned at an appropriate timing according to the port number.

The communication terminal device may be configured as follows. That is, the waiting time setting unit is preferably configured to set a plurality of waiting times to be compatible with types of the OSs. The transmitting unit is configured to select and use any one of the plurality of waiting times set in the waiting time setting unit according to the type of the OS.

Since this allows the waiting time to be varied by OS, a response can be returned at an appropriate timing according to the type of the OS of the operating terminal device.

According to another preferred embodiment of the present invention, a communication terminal device includes a receiving unit, a response generating unit, and a transmitting unit. The receiving unit is configured to receive a request via a non-persistent connection. The response generating unit is configured to generate data for response to the request. The transmitting unit is configured to transmit the data for response via the non-persistent connection after a predetermined waiting time elapses from reception of the request.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view illustrating a multifunctional peripheral according to a preferred embodiment of the present invention.

FIG. 2 is a block diagram illustrating the multifunctional peripheral and a PC.

FIG. 3 is a flowchart illustrating processing in which the multifunctional peripheral returns a response.

FIG. 4 is a view schematically illustrating contents set in a waiting time setting unit.

FIG. 5 is a view schematically illustrating contents set in the waiting time setting unit according to another preferred embodiment of the present invention.

FIG. 6 is a view schematically illustrating contents set in the waiting time setting unit according to still another preferred embodiment of the present invention.

### DETAILED DESCRIPTION OF THE PREFERRED EMBODIMENTS

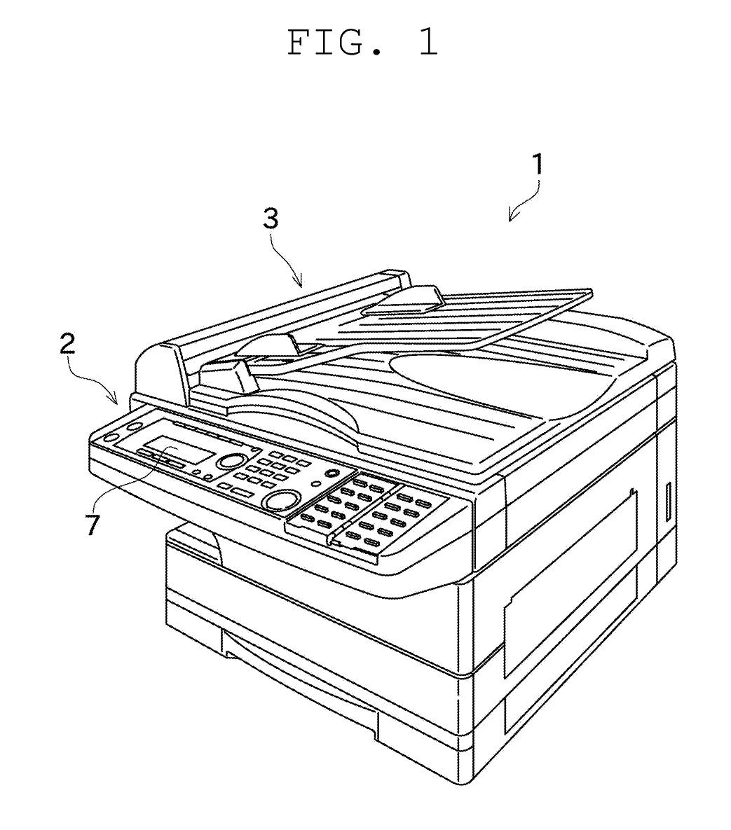

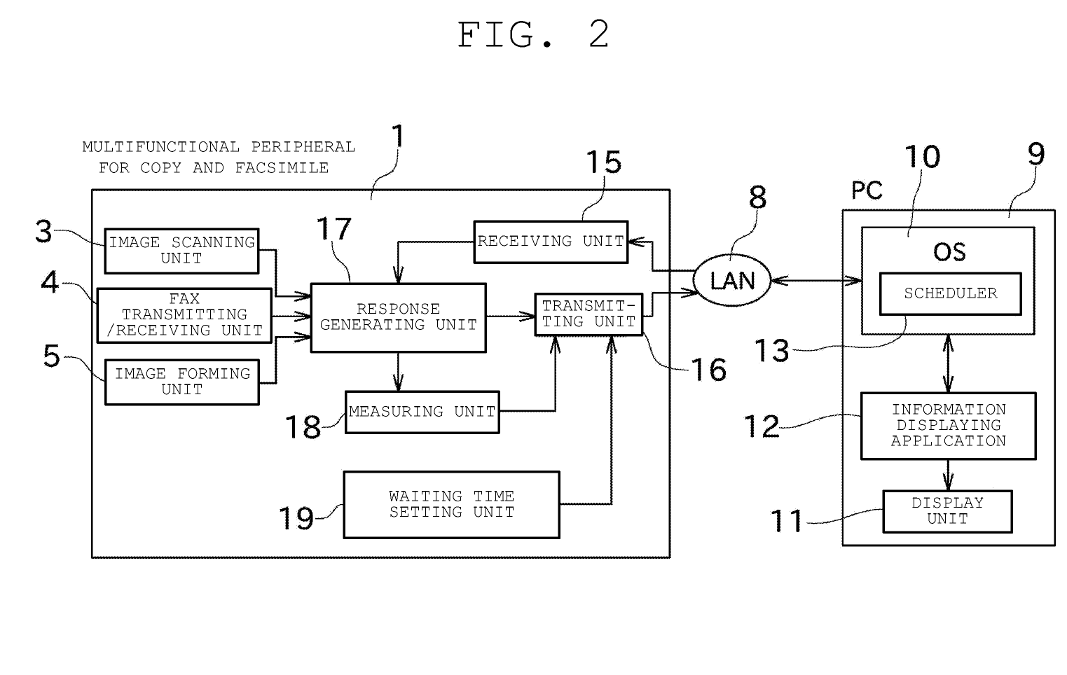

Next, preferred embodiments of the present invention will be described with reference to the following drawings. FIG. 1 illustrates a perspective view of a multifunctional peripheral 1 for performing copy and facsimile functions (a communication terminal device) according to the present preferred embodiment. The multifunctional peripheral 1 is configured to be capable of communicating with a PC (Personal Computer) 9 as an operating terminal device via a network such as a LAN (Local Area Network) 8 as illustrated in FIG. 2.

The multifunctional peripheral 1 of the present preferred embodiment includes an operating unit 2 provided with various buttons and the like for a user to operate and a display unit 7 capable of displaying various messages. Furthermore, the multifunctional peripheral 1 includes an image scanning unit 3, a facsimile transmitting/receiving unit 4, and an image forming unit 5.

The image scanning unit 3 is capable of scanning an image on a surface of a set original document. The facsimile transmitting/receiving unit 4 is capable of transmitting/receiving a facsimile via a telephone line. The image forming unit 5 prints, on a printing paper, an image scanned by the image scanning unit 3 or a facsimile received by the facsimile transmitting/receiving unit 4. Since configurations of the image scanning unit 3, the facsimile transmitting/receiving unit 4, the image forming unit 5, or the like have been publicly known, detailed descriptions thereof will be omitted.

The PC 9 is configured as a publicly-known personal computer and includes a display unit 11 such as a liquid crystal display. Furthermore, an OS (Operating system) 10 compatible with the network is installed in the PC 9.

An information displaying application 12 arranged to run on the OS 10 is installed in the PC 9. The information displaying application 12 is configured to display, on the display unit 11, information relating to a state of the multifunctional peripheral 1. The state of the multifunctional peripheral 1 to be displayed by the information displaying application 12 is, for example, a remaining amount of toner, a printing condition, a transmitting/receiving condition of a facsimile, or the like. Additionally, in a case where a trouble such as paper jam or toner depletion occurs in the multifunctional peripheral 1, the information displaying application 12 displays, on the display unit 11, information relating to the trouble. This allows a user of the PC 9 to monitor the state of the remotely-located multifunctional peripheral 1.

The OS 10 has a function to communicate with the multifunctional peripheral 1 via the LAN 8. The OS 10 also includes a scheduler 13 such that a predetermined task can be performed at a predetermined time interval. A task of requesting information relating to the present state from the multifunctional peripheral 1 is registered in the scheduler 13. This allows the OS 10 to transmit a request to the multifunctional peripheral 1 periodically (e.g., preferably at 30 second intervals in the present preferred embodiment).

When transmitting a request to the multifunctional peripheral 1, the OS 10 establishes a connection with the multifunctional peripheral 1 via the LAN 8. The connection is established by specifying a predetermined port number in accordance with a predetermined communication protocol. In the present preferred embodiment, a communication protocol between the OS 10 and the LAN 8 is set to an IPP (Internet Printing Protocol). Since a port number used for communication in a case of the IPP is prescribed, communication is performed by specifying the port.

The OS 10 transmits, to the multifunctional peripheral 1 via the connection, data for requesting information on the present state of the multifunctional peripheral 1. In a case of receiving the request from the OS 10, the multifunctional peripheral 1 is configured to return response data for this request to the OS 10 via the connection. The OS 10 transfers, to the information displaying application 12, the response data received from the multifunctional peripheral 1.

The information displaying application 12 obtains the present state of the multifunctional peripheral 1 by analyzing the response data received from the OS 10, and displays the present state of the multifunctional peripheral 1 on the display unit 11. In such a manner, the information displaying application 12 can display the present state of the multifunctional peripheral 1 on the display unit 11 of the PC 9.

As described above, since a request is periodically transmitted to the multifunctional peripheral 1, the information displaying application 12 can periodically obtain information indicating a state of the multifunctional peripheral 1. This allows the information displaying application 12 to constantly display updated information on the display unit 11.

The connection between the OS 10 and the multifunctional peripheral 1 is configured to be established every time the OS 10 transmits a request and be closed after the OS 10 receives response data from the multifunctional peripheral 1. In the present preferred embodiment, the connection is configured to be established every time the information is transmitted/received between the OS 10 and the multifunctional peripheral 1. The connection between the OS 10 and the multifunctional peripheral 1 thus can be defined as a non-persistent connection.

Next, a configuration of the multifunctional peripheral will be described in more detail. As described above, the multifunctional peripheral 1 includes the image scanning unit 3, the facsimile transmitting/receiving unit 4, and the image forming unit 5. Furthermore, the multifunctional peripheral 1 includes a receiving unit 15, a transmitting unit 16, a response generating unit 17, a measuring unit 18, and a waiting time setting unit 19.

The receiving unit 15 is configured to receive a request from the OS 10 via a connection established with the OS 10.

The response generating unit 17 is configured to generate data for response (response data) in response to a request. In the present preferred embodiment, the response generating unit 17 is configured to collect information on the present state of the multifunctional peripheral 1 by communicating with each unit of the multifunctional peripheral 1. The response generating unit 17, for example, obtains information such as transmitting/receiving state of a facsimile by communicating with the facsimile transmitting/receiving unit 4. The response generating unit 17, for example, also obtains information such as a remaining amount of toner by communicating with the image forming unit 5. Subsequently, the response generating unit 17 generates response data by integrating necessary information from the obtained information.

The transmitting unit 16 is configured to transmit, to the OS 10 via the connection, the response data prepared by the response generating unit 17.

Next, a characteristic configuration of the multifunctional peripheral 1 of the present preferred embodiment will be described.

The inventor of the present application has discovered that in a case where communication is performed between the multifunctional peripheral 1 of the present preferred embodiment and the OS 10, the OS 10 exhibits an unexpected behavior in some cases. An example of the problem is that after the multifunctional peripheral 1 returned a response to a request from the OS 10, any request that was to be periodically transmitted from the OS 10 was not transmitted.

In communication between a conventional multifunctional peripheral and the OS 10, the above-described problem did not occur. Therefore, a cause of the unexpected behavior exhibited by the OS 10 was initially not identified at all so that it was also unknown which of the multifunctional peripheral 1 or the OS 10 was responsible for causing the problem.

As a result of repeating experiments, the inventor of the present application has discovered that in a case where the multifunctional peripheral 1 returns a response, to a request from a certain type of OS, for example, in about 0.007 seconds, the OS exhibits the above-described unexpected behavior, but in a case where the multifunctional peripheral 1 returns a response in about 0.008 seconds, the unexpected behavior is not observed.

In other words, it has become apparent that a response to a request from the OS 10 that is too early and returned from the multifunctional peripheral 1 makes the OS 10 exhibit the unexpected behavior. Although a cause of the unexpected behavior by the OS 10 in a case of a response that is too early is not identified, it has been discovered that as long as a predetermined interval or longer is secured from when the multifunctional peripheral 1 receives a request until the multifunctional peripheral 1 returns a response, the unexpected behavior by the OS 10 is reliably prevented.

In a description hereinafter, a time from when the receiving unit 15 of the multifunctional peripheral 1 receives a request from the OS 10 until the transmitting unit 16 transmits a response to the OS 10 is defined as a response time. A longest response time when the OS 10 exhibits the unexpected behavior is defined as a limit response time.

Since a conventional multifunctional peripheral requires a time longer than the limit response time to prepare response data, returning a response in a time shorter than the limit response time was not possible. Therefore, the OS 10 exhibited no unexpected behavior in the past.

However, recently improved processing capabilities of multifunctional peripherals have generated cases where response data can be prepared in a time shorter than the limit response time. This allows the multifunctional peripheral 1 of the present preferred embodiment to return a response in a time shorter than the limit response time, thus causing a problem that the OS 10 exhibits the unexpected behavior.

Based on the above-described discoveries, the multifunctional peripheral 1 of the present preferred embodiment is configured to return a response after receiving a request from the OS 10 and then waiting for a time longer than the limit response time.

A specific description will be made below with reference to FIG. 2 and FIG. 3.

The measuring unit 18 provided in the multifunctional peripheral 1 of the present preferred embodiment is configured to measure a time from when a request from the OS 10 is received by the receiving unit 15 until the response generating unit 17 completes generation of response data.

As illustrated in a flowchart in FIG. 3, when a request from the OS 10 is received by the receiving unit 15 (step S101), the measuring unit 18 starts to measure a time (step S102).

Sequentially, the response generating unit 17 generates response data (step S103). The response generating unit 17 outputs the generated response data to the transmitting unit 16.

After the response generating unit 17 completes generation of the response data, the measuring unit 18 ends measurement of the time (step S104). The time that the measuring unit 18 measured between step S102 and step S104 is defined as a response data generation time. The measuring unit 18 outputs the measured response data generation time to the transmitting unit 16.

The multifunctional peripheral 1 of the present preferred embodiment includes the waiting time setting unit 19 in which a predetermined waiting time is set.

The transmitting unit 16 obtains the waiting time set in the waiting time setting unit 19. Sequentially, the transmitting unit 16 compares the response data generation time measured by the measuring unit 18 with the waiting time obtained from the waiting time setting unit 19 (step S105).

In a case where the response data generation time is shorter than the waiting time, after waiting from a time point when the request is received (a time point of step S101) until the waiting time elapses (step S106), the transmitting unit 16 transmits the response data to the OS 10 (step S107).

In other words, even in a case where a response data is able to be quickly generated, the multifunctional peripheral 1 does not immediately transmit the data and waits to transmit the data for a period until the waiting time elapses. This prevents the OS 10 from exhibiting the unexpected behavior.

On the other hand, a response data generation time is the same as or longer than the waiting time (in a case where preparation of the response data takes time), the transmitting unit 16 transmits the response data to the OS 10 without waiting (step S107).

The waiting time is set to be longer than the limit response time. The limit response time can be obtained by experiments which make the multifunctional peripheral 1 and the OS 10 actually communicate with each other.

However, in practicing various preferred embodiments of the present invention, it is not required to obtain an exact limit response time. The point is that the waiting time is merely required to be set such that the OS 10 does not exhibit the unexpected behavior. As described above, for example, a certain type of OS does not exhibit the unexpected behavior if the time until a response is returned is about 0.008 seconds, for example. In other words, this shows that a limit response time for this OS is less than about 0.008 seconds, for example. The waiting time for this OS thus may be set to an appropriate value equal to or more than about 0.008 seconds, for example.

A type of the OS 10 for the PC 9 to be connected to the multifunctional peripheral 1 is not limited. Any OS having a network function can exchange information with the multifunctional peripheral 1 via the LAN 8. In other words, the multifunctional peripheral 1 is expected to communicate with various types of OSs that are different in manufacturer or version thereof. Since the limit response time is considered to be different for each OS, the waiting time is preferably varied according to a type of an OS with which communication is made.

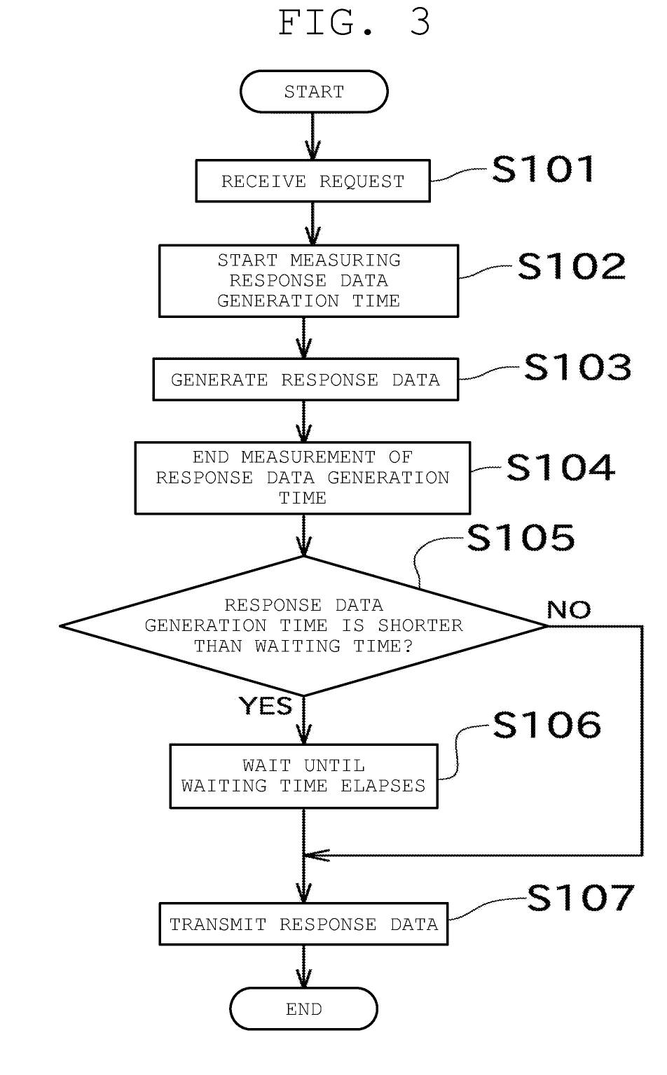

A plurality of the waiting times is thus set in the waiting time setting unit 19 of the present preferred embodiment. Contents set in the waiting time setting unit 19 are schematically illustrated in FIG. 4.

In the present preferred embodiment, the waiting time setting unit 19 is configured to set the plurality of waiting times to be compatible with the types of the OSs. In FIG. 4, for example, the waiting time of about 0.008 seconds is preferably set for an OS of which type is “A”, for example. The waiting time of about 0.003 seconds and the waiting time of about 0.010 seconds preferably are respectively set for an OS of which type is “B” and for an OS of which type is “C”, for example. A default waiting time (“default” in FIG. 4) is set in the waiting time setting unit 19 of the present preferred embodiment.

The transmitting unit 16 is configured to discern the type of the OS 10. In the present preferred embodiment, since the IPP preferably is used in a communication protocol with the OS 10, the transmitting unit 16 can judge the type of the OS 10 by checking upon a User-Agent field of an http header in a request transmitted from the OS 10.

The transmitting unit 16 obtains the waiting time according to the type of the OS 10 by referring to the set contents of the waiting time setting unit 19. The transmitting unit 16 uses a waiting time obtained in the above-described manner in determination of step S105 and in waiting processing of step S106. This allows the multifunctional peripheral 1 to wait for transmission for an appropriate period of time according to the type of the OS.

In a case where the type of the OS 10 is unknown or in a case where the type of the OS 10 cannot be judged, the transmitting unit 16 is configured to use the default waiting time.

As described above, the multifunctional peripheral 1 of the present preferred embodiment preferably includes the receiving unit 15, the response generating unit 17, and the transmitting unit 16. The receiving unit 15 receives a request via a non-persistent connection established with the OS 10 of the PC 9 via the LAN 8. The response generating unit 17 generates data to respond to the request. The transmitting unit 16 transmits the data for response to the OS 10 via the non-persistent connection after the predetermined waiting time elapses from reception of the request. The non-persistent connection is established every time the OS 10 transmits the request and is closed by the OS 10's reception of the response.

The multifunctional peripheral 1 of the present preferred embodiment can also be configured as follows. That is, the multifunctional peripheral 1 of the present preferred embodiment preferably includes the receiving unit 15, the response generating unit 17, and the transmitting unit 16. The receiving unit 15 receives a request via a non-persistent connection. The response generating unit 17 generates data for response to the request. The transmitting unit 16 transmits the data for response via the non-persistent connection after the predetermined waiting time elapses from reception of the request.

As described above, by preventing the response to the request from being immediately returned, the OS 10 of the PC 9 can be prevented from exhibiting the unexpected behavior.

The multifunctional peripheral 1 of the present preferred embodiment includes the measuring unit 18 arranged to measure a response data generation time from reception of a request until the response generating unit 17 completes generation of data for response. In a case where a response data generation time is shorter than the waiting time, the transmitting unit 16 waits to transmit data for response for a period of time from reception of a request until the waiting time elapses. In a case where a response data generation time is longer than the waiting time, the transmitting unit 16 transmits data for response without waiting.

As described above, in a case where data for response is prepared in a time shorter than the waiting time, the transmitting unit 16 is configured to wait to transmit the data. This reliably prevents the OS 10 of the PC 9 from exhibiting the unexpected behavior. On the other hand, in a case where preparation of data for response requires a time that is longer than the waiting time, a decrease in responsiveness can be prevented by immediately transmitting the data.

The multifunctional peripheral 1 of the present preferred embodiment preferably includes the waiting time setting unit 19 in which a plurality of the waiting times can be set.

By setting the plurality of waiting times, an appropriate waiting time can be selected according to a condition.

In the multifunctional peripheral 1 of the present preferred embodiment, the waiting time setting unit 19 sets the plurality of waiting times to be compatible with the types of the OSs. The transmitting unit 16 selects and uses any one of the plurality of waiting times set in the waiting time setting unit 19 according to the type of the OS 10 of the PC 9.

Since this allows the waiting time to be varied by OS, the response can be returned at an appropriate timing according to the type of the OS 10 of the PC 9.

Next, another preferred embodiment of the present invention will be described.

In the above-described preferred embodiment, the communication protocol between the multifunctional peripheral 1 and the OS 10 preferably is set to the IPP. However, a communication protocol between the multifunctional peripheral 1 and the OS 10 is not limited thereto, and another protocol such as a SMB (Server Message Block) or a LPR (Line Printer daemon protocol) can be used, for example. Furthermore, these protocols can be selectively used according to circumstances.

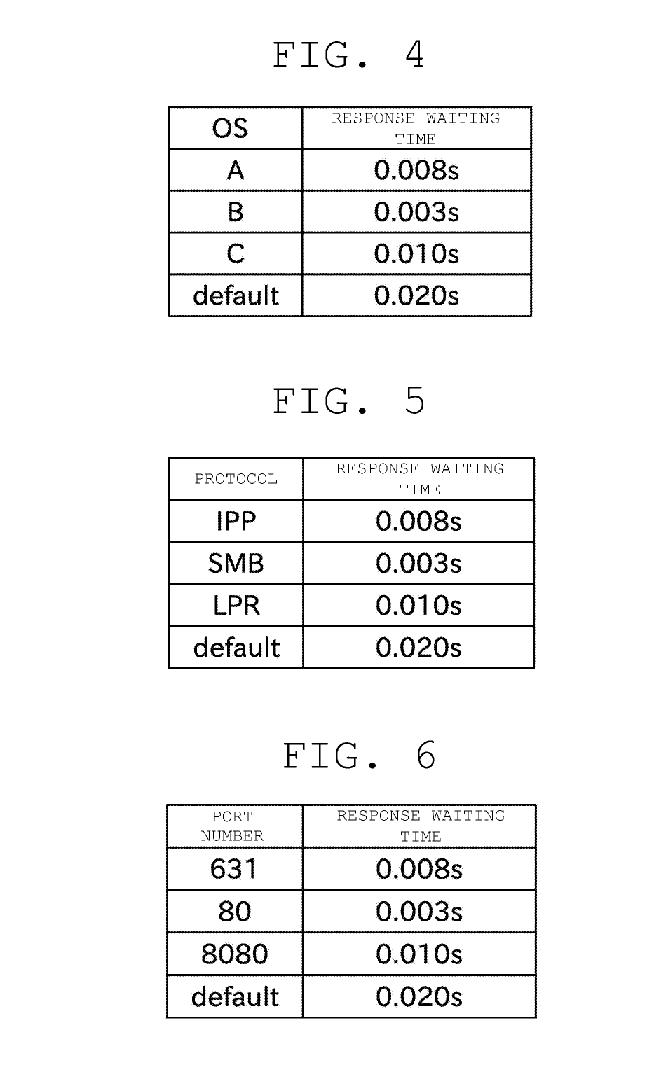

A multifunctional peripheral of the present preferred embodiment sets, in the waiting time setting unit 19, a plurality of waiting times to be compatible with different types of the protocols. Set contents in the waiting time setting unit 19 in the present preferred embodiment are schematically illustrated in FIG. 5.

The transmitting unit 16 obtains, by referring to the set contents in the waiting time setting unit 19, a waiting time compatible with a protocol used in communication with the OS 10. The transmitting unit 16 uses, in the determination of step S105 and in the waiting processing of step S106, the waiting time obtained in the above-described manner. This allows the waiting time to be varied according to the communication protocol.

Similarly, a plurality of waiting times may be set in the waiting time setting unit 19 to be compatible with port numbers. Set contents in the waiting time setting unit 19 in this case are schematically illustrated in FIG. 6.

The transmitting unit 16 obtains, by referring to the set contents in the waiting time setting unit 19, a waiting time compatible with a port number of the OS 10 side. The transmitting unit 16 uses, in the determination of step S105 and in the waiting processing of step S106, the waiting time obtained in the above-described manner. This allows the waiting time to be varied according to the port number of the OS 10 side.

Although the preferred embodiments have been described above, configurations thereof may be, for example, modified as follows.

Although not illustrated, a plurality of PCs (operating terminal devices) can be connected to the multifunctional peripheral 1 via the LAN 8. In this case, the types of OSs of respective PCs may vary from each other. Additionally, the multifunctional peripheral 1 can communicate with an OS of each PC using a protocol, each of which protocol is different from each other.

In the above-described preferred embodiments, although the multifunctional peripheral 1 and the OS 10 are preferably connected via the LAN 8, a network that connects the multifunctional peripheral 1 and the OS 10 is not limited to a LAN, and the network may be a WAN (Wide Area Network) such as the internet, for example. Further, another apparatus (e.g., a relay server) may be arranged between the multifunctional peripheral 1 and the OS 10.

In the above-described preferred embodiments, a request from the OS 10 preferably includes contents that request information relating to the present state of the multifunctional peripheral 1. However, contents of a request from the OS 10 are not limited. Similarly, contents of a response from the multifunctional peripheral 1 are not limited. The present invention can be applied to any configuration in which a communication terminal device (the multifunctional peripheral 1) transmits some kind of response in response to some kind of request from the OS 10.

In the above-described preferred embodiments, although a request from the OS 10 is preferably set to be periodically transmitted, the present invention is not limited to this configuration. A request from the OS 10 to the multifunctional peripheral 1 may be, for example, non-periodically transmitted. Furthermore, the present invention may be applied even to a case where a request from the OS 10 to the multifunctional peripheral 1 is transmitted only once.

The communication terminal device is not limited to a multifunctional peripheral for performing a copy function and a facsimile function, and the present invention can be applied to any apparatus configured to return some kind of response to a received request via a non-persistent connection. Furthermore, the operating terminal device is not limited to a PC, and the present invention can be applied to any apparatus arranged to transmit some kind of request via a non-persistent connection and receive a response to the request.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. (canceled)

2. A communication terminal device comprising:
a receiving unit arranged to receive a request via a non-persistent connection established via a network with an operating system of an operating terminal device;
a response generating unit arranged to generate data for response to the request; and
a transmitting unit arranged to transmit the data for response to the operating system via the non-persistent connection after a predetermined waiting time elapses from reception of the request; wherein
the non-persistent connection is established every time the operating system transmits the request and closed upon receipt of the response by the operating system.

3. The communication terminal device according to claim 2, further comprising a measuring unit arranged to measure a generation time from reception of the request until the response generating unit completes generation of the data for response; wherein
in a case in which the generation time is shorter than the waiting time, the transmitting unit is configured to wait to transmit the data for response for a period of time from reception of the request until when the waiting time elapses; and
in a case in which the generation time is longer than the waiting time, the transmitting unit is configured to transmit the data for response without waiting.

4. The communication terminal device according to claim 2, further comprising a waiting time setting unit arranged to set a plurality of the waiting times.

5. The communication terminal device according to claim 4, wherein
the waiting time setting unit is configured to set the plurality of waiting times to be compatible with protocols; and
the transmitting unit is configured to select and use any one of the plurality of waiting times set in the waiting time setting unit according to a protocol of the non-persistent connection.

6. The communication terminal device according to claim 4, wherein
the waiting time setting unit is configured to set the plurality of waiting times to be compatible with port numbers; and
the transmitting unit is configured to select and use any one of the plurality of waiting times set in the waiting time setting unit according to a port number of the operating system.

7. The communication terminal device according to claim 4, wherein
the waiting time setting unit is configured to set the plurality of waiting times to be compatible with a type of the operating system; and
the transmitting unit is configured to select and use any one of the plurality of waiting times set in the waiting time setting unit according to the type of the operating system.

8. A communication terminal device comprising:
a receiving unit arranged to receive a request via a non-persistent connection;
a response generating unit arranged to generate data for response to the request; and
a transmitting unit arranged to transmit the data for response via the non-persistent connection after a predetermined waiting time elapses from reception of the request.
